(19) United States
(12) Patent Application Publication
(10) Pub. No.: US 2010/0131310 A1
(43) Pub. Date: May 27, 2010

(54) SYSTEM AND METHOD FOR CARRIER CAPACITY AND ALLOCATION MANAGEMENT

(75) Inventors: Daniel Roy Wall, Auburn, WA (US); Neven Stojanovic, Bellevue, WA (US); David Vinton Stack, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: EXPEDITORS INTERNATIONAL OF WASHINGTON INC., Seattle, WA (US)

(21) Appl. No.: 12/268,611

(22) Filed: Nov. 11, 2008

(51) Int. Cl. G06Q 10/00; G06F 7/06; G06F 17/30

(52) U.S. Cl. 705/7

(57) ABSTRACT

Generally described, aspects of the present invention are directed at software systems for managing the logistics of one or more voyages. In accordance with one embodiment, a method is provided for collecting and disseminating voyage data in a computer networking environment. In this regard, the method includes providing a user interface that is accessible in the computer networking environment configured with controls for accepting input from one or more users. Then, a set of voyage data is collected from the user interface that describes the attributes of the cargo scheduled to be shipped on a voyage. As data is obtained from users, the method calculates a set of utilization statistics based on the collected voyage data that describes the extent that the capacity available from a carrier will be utilized. In this regard, the collected voyage data and utilization statistics may be accessed by authorized users from a central location.

### BACKGROUND

Transactions that involve the shipment of cargo typically have numerous logistics issues. By way of example, cargo may have different origin/destination locations, be transported using various carriers, and involve multiple remotely-located entities. In this regard, computer networks configured to exchange data according to common protocols, are increasingly used to perform a variety of tasks between remote systems and users. The connectivity available from computer networks provides an opportunity to more efficiently manage the logistics involved in the shipment of cargo.

A typical shipment may involve many entities, different types of documentation, and take weeks or months to complete. The entities may include one or more freight forwarders, carriers, importers/exporters, and the like. Those skilled in the art and others will recognize that a freight forwarder is typically an agent for an importer/exporter in facilitating the shipment of cargo between different countries. Typically, freight forwarders are familiar with the import/export regulations of various countries, the methods of shipping, and documentation requirements in completing a shipment. Moreover, freight forwarders will typically advise importers/exporters on freight costs, port charges, and manage the packing methods that will protect cargo during transit. For example, freight forwarders may arrange to have cargo packed at a port and containerized. Other entities are frequently inexperienced in conducting international transactions and may lack knowledge of the wide variety of requirements for transporting cargo. The lack of experience and coordination between entities involved in a shipment has led to noncompliance issues, excessive delivery times, and other logistic inefficiencies.

Some existing systems implement functions to track and manage the logistics involved in a shipment using e-mail to share spreadsheets and/or database files. An entity may input data in a file and transmit the updated file to one or more other entities. Since these systems do not centralize the collection and dissemination of data, the ability of some entities to access up-to-date information related to the shipment may be limited. More specifically, all of the entities may not have real-time access to at least some information since the data is not accessible from a central location.

A network interface such as a Web site or network portal may be used to centralize the collection and dissemination of data. However, existing systems do not allow multiple entities involved in a shipment to effectively collaborate from a network interface. In this regard, entities may have different roles in the shipment and should not have the same authority in accessing data related to a shipment. A freight forwarder may want to manage the overall logistics of the shipment to ensure that delivery dates, shipment allocations, and other requirements are satisfied. Conversely, carriers and other entities have different roles and should be allocated the same authority as a freight forwarder. Accordingly, a need exists for systems that allow data collection and dissemination of data related to a shipment from a central location. In this regard, the system should facilitate collaboration between entities with different authority in coordinating the movement of cargo.

### SUMMARY

This summary is provided to introduce a selection of concepts in a simplified form that is further described below in the Detailed Description. This summary is not intended to identify key features of the claimed subject matter nor is it intended to be used as an aid in determining the scope of the claimed subject matter.

Generally described, aspects of the present invention are directed at software systems for managing the logistics of a voyage involved in the shipment of cargo. In accordance with one embodiment, a method is provided for collecting and disseminating voyage data in a computer networking environment. In this regard, the method includes providing a user interface that is accessible in the computer networking environment configured with controls for accepting input from one or more users. Then a set of voyage data is collected from the user interface that describes the attributes of the cargo scheduled to be shipped. As data is obtained from users, the method calculates a set of utilization statistics based on the collected voyage data that describes the extent that the capacity available from a carrier will be utilized. In this regard, the collected voyage data and utilization statistics may be accessed by authorized users from a centralized location.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram depicting an illustrative networking environment suitable for managing the logistics of a voyage in accordance with an aspect of the present invention;

FIG. 2 is a block diagram that depicts various components associated with a management application in accordance with an aspect of the present invention;

FIG. 3 is a pictorial depiction of an exemplary Web page suitable to present voyage data and obtain input from a user in accordance with one embodiment of the present invention;

FIG. 4 is a flow diagram of an exemplary method for managing the collection of voyage data in accordance with one aspect of the present invention;

FIG. 5 is a pictorial depiction of an exemplary Web page that allows a user to create a new voyage in accordance with one embodiment of the present invention; and

FIGS. 6A-B are pictorial depictions of exemplary Web pages that allow users to access particular data sets associated with a selected voyage in accordance with additional embodiments of the present invention.

### DETAILED DESCRIPTION

The detailed description set forth below in connection with the appended drawings is intended as a description of various embodiments of the present invention and is not intended to represent the only embodiments. Each embodiment described in this disclosure is provided merely as an example or illustration and should not be construed as preferred or advantageous over other embodiments. In this regard, the following description first provides an overview of a system in which the present invention may be implemented. Then an exemplary method is described. The illustrative examples provided herein are not intended to be exhaustive or to limit the invention to the precise forms disclosed. Similarly, any steps described herein may be interchangeable with other steps, or combinations of steps, in order to achieve the same result.

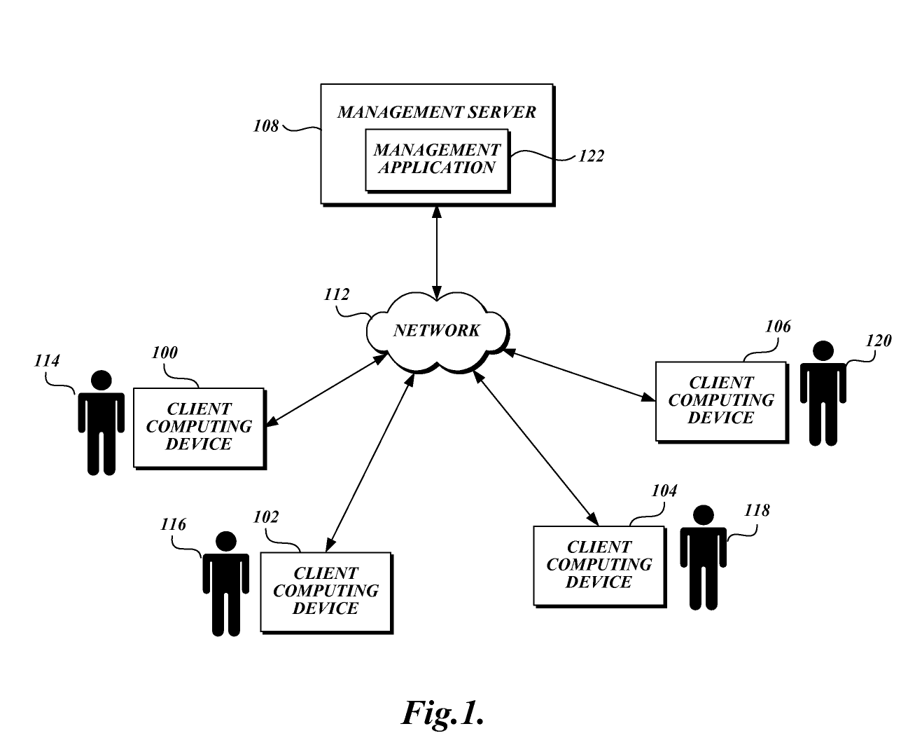

The following discussion is intended to provide a brief, general description of a computing system suitable for implementing various features of the invention. While the computing system will be described in the general context of computers linked together through a communication network, those skilled in the art will appreciate that the invention may be implemented in other contexts. For example, the invention may be practiced using direct communication links and may utilize different types of computing devices than those illustrated in FIG. 1.

Referring to FIG. 1, the following is intended to provide an exemplary overview of one computer networking environment in which the present invention may be implemented. In this regard, the networking environment depicted in FIG. 1 includes a plurality of client computing devices 100, 102, 104, and 106 and a management server 108. The management server 108 is configured to communicate with the client computing devices 100-106 via a network 112 that may be implemented as a local area network (“LAN”), wide area network (“WAN”), wireless network, or even a direct communication link. As known to those skilled in the art and others, the computing devices illustrated in FIG. 1 may be configured to exchange documents, commands, and other types of data over the network 112. In the embodiment illustrated in FIG. 1, the client computing device 100 is shown associated with the freight forwarder 114. Moreover, the client computing devices 102-106 are associated with the carrier A 116, carrier B 118, and exporter 120, respectively.

In one embodiment, the management server 108 may include a management application 122 that is designed to facilitate the management of logistics related to a voyage that is used in the shipment of cargo. In this regard, the management server 108 may be implemented as one or more Web servers that return files and/or other data to client computing devices 100-106 in response to receiving a request. Typically, data is returned in the form of Web pages and accessed on the client computing devices 100-106 using a Web browser application. Those skilled in the art and others will recognize that a Web server supports the transmission of Web pages formatted in a markup language, such as the HyperText Markup Language (“HTML”). However, while the description is provided in the context of the Internet and HTML documents, other embodiments are within the scope of the claimed subject matter. Moreover, while the management server 108 is depicted as a single computing device, those skilled in the art will recognize that it may be implemented as a “server farm” in which multiple computing devices coordinate to provide the functionality that is implemented by the present invention.

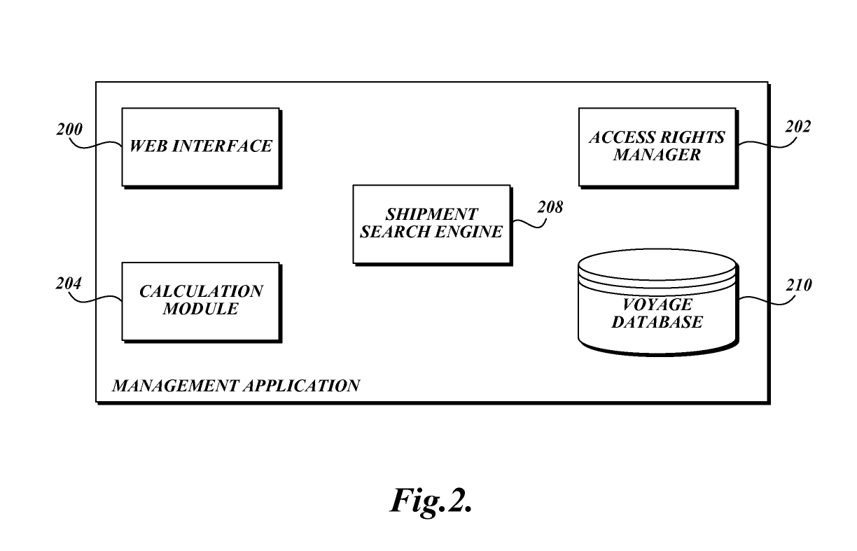

Now with reference to FIG. 2, various components of the management application 122, also depicted in FIG. 1, will be described. In the embodiment illustrated in FIG. 2, the management application 122 includes a Web interface 200, access rights manager 202, calculation module 204, a shipment search engine 208, and a voyage database 210. Generally described, these components of the management application 122 implement functionality to (1) centralize the collection and dissemination of data in managing the logistics of a voyage, (2) manage access rights to the collected voyage data, (3) satisfy search requests for data items associated with a voyage, and (4) calculate utilization statistics based on voyage data uploaded by various users. In accordance with one embodiment, the management application 122 stores data in fields maintained in the voyage database 210. For example, data that is associated with a voyage represented in the voyage database 210 may include route number, name, voyage number, and the like. In order to access specific voyage data sets, the management application 122 may issue a database query that is submitted to the voyage database 210.

As further illustrated in FIG. 2, the management application 122 includes a Web interface 200 that allows the Internet to be utilized as a platform for centralizing collection and dissemination of data related to a voyage. For example, through a set of requests/response interactions with the Web interface 200, an exporter may create a new voyage. Then other entities involved in the shipment of cargo may upload various data items that may include purchase orders, container specifications, port information, etc. From the Web interface 200, uploaded data items may be monitored and modified, if necessary. Ultimately, the Web interface 200 allows an authorized user to approve a voyage for shipment.

In one embodiment, the access rights manager 202 depicted in FIG. 2 controls an entity's right to access resources that are available from the Web interface 200. As mentioned previously, freight forwarders, importers/exporters, and carriers may each have a role in the shipment of cargo. However, each entity has different responsibilities and is assigned access rights accordingly. In this regard, the right to access resources provided by the present invention is enforced by the access rights manager 202.

As further illustrated in FIG. 2, the management application 122 includes a calculation module 204. In one embodiment, various data items describing cargo that will be shipped are uploaded to the Web interface 200. By way of example, allocation data for a voyage that identifies the cargo space that is being allocated on a particular carrier is uploaded. Then “purchase orders” that represents a transaction between a buyer and seller and associated container information may be uploaded. Generally described, the calculation module 204 is configured to access data related to a voyage and perform various calculations that quantify the extent that the capacity available from the carrier is being utilized.

As illustrated in FIG. 2, the management application 122 also includes a shipment search engine 208 for identifying specific data items related to a voyage. In one embodiment, the shipment search engine 208 applies a keyword search algorithm similar to algorithms applied by Internet-based search engines to identify data maintained in the voyage database 210. For example, a user may generate a search request by inputting a keyword associated with a seller. In response, the shipment search engine 208 may submit a query to the voyage database 210 to identify purchase orders associated with the identified seller.

The components of the management application 122 described above collectively allow entities involved in a shipment to collaborate in real-time. As mentioned above, the shipment of cargo may involve multiple entities, with each entity having a distinct role in completing the shipment. In one embodiment, the management application 122 is configured to collect and disseminate data in order to coordinate the movement of cargo. As mentioned previously, freight forwarders typically manage the overall logistics of a shipment and may be responsible for satisfying documentation requirements of a port authority, containerizing cargo, and the like. Conversely, carriers are typically responsible for the physical transportation of cargo within a larger transportation network. Accordingly, the management application 122 implements functionality that allows an appropriate entity to establish a shipment schedule. Once scheduled, shipment data is collected and disseminated in a way that enables real-time collaboration between each entity involved in the shipment. In other words, the management application 122 supports data sharing to coordinate the shipment of cargo involving multiple entities.

In one aspect, the present invention centralizes the collection and dissemination of data in a way that allows entities with different authority to collaborate. However, allowing freight forwarders, carriers, and exporters to work on the same data and otherwise collaborate within a common system raises challenging issues. In this regard, each of these entities has different responsibilities in completing a shipment and should not have the same authority when interacting with the management application 122. Accordingly, functionality to allocate and enforce access rights that is appropriate given each entities responsibilities is provided. By way of example, authority may be granted so that only a particular user associated with an exporter is able to schedule or approve a shipment. Moreover, the actions that a carrier can perform may be limited to accessing and providing information related to a shipment in which the carrier is involved. By separating authority in this way, the collection and dissemination of data may be centralized while still allowing multiple entities to work within the same system.

Those skilled in the art and others will recognize that the component architecture of the management application 122 illustrated in FIG. 2 is a highly simplified example that only illustrates components necessary for an understanding of the claimed subject matter. In other embodiments, the management application 122 may have fewer or additional components then those illustrated in FIG. 2.

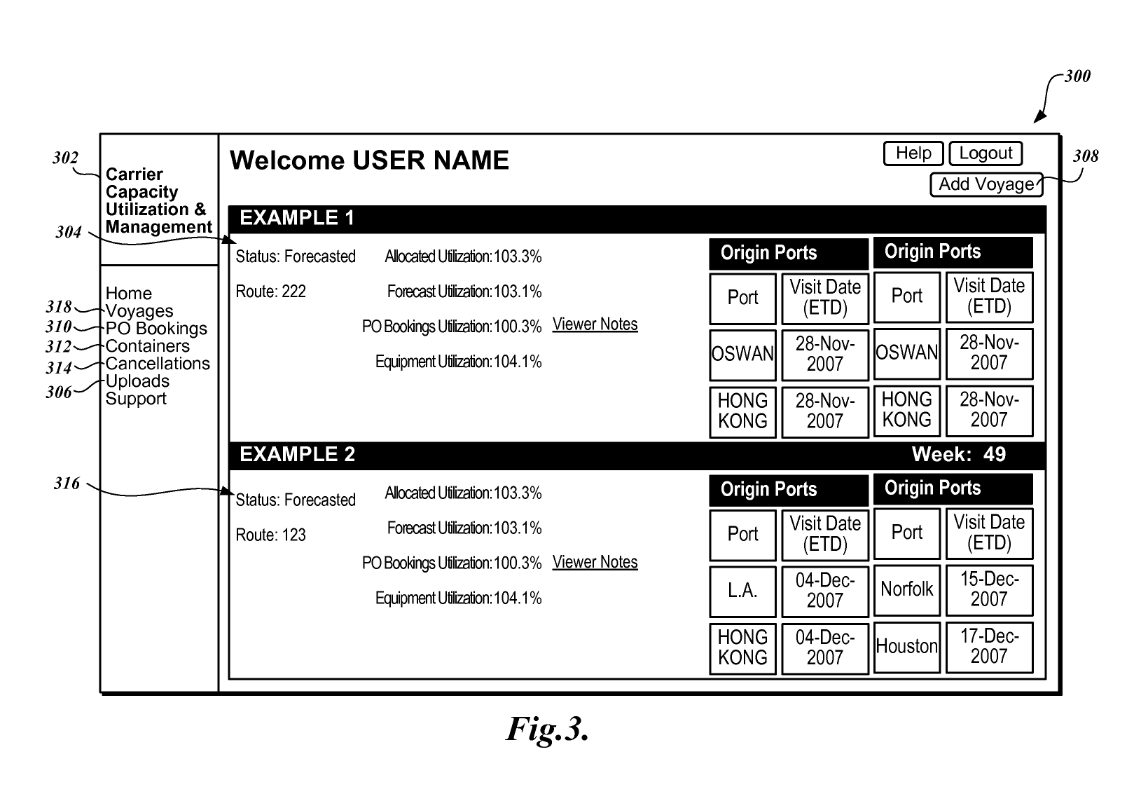

Now with reference to FIG. 3, an exemplary Web page 300 that may be used to illustrate aspects of the present invention will be described. In one embodiment, a user may login at a Web interface 200 provided by the present invention. Once the login procedure is complete, a “home” page (e.g., Web page 300) may be presented that includes the currently scheduled voyages and various controls for obtaining input from the user. In this exemplary embodiment, the Web page 300 includes a sidebar region 302, a first voyage description region 304, a second voyage description region 306, and an add voyage button 308.

As illustrated in FIG. 3, each of the description regions 304-306 provides a set of information about a particular voyage that includes status and route information, utilization data, as well as port information. Moreover, by interacting with controls available from the sidebar region 302, a user may generate a request to navigate away from the Web page 300 and access other types of voyage data. Also, a user may activate the add voyage button 308 in order to access a Web page that allows a user to input data that describes a new voyage.

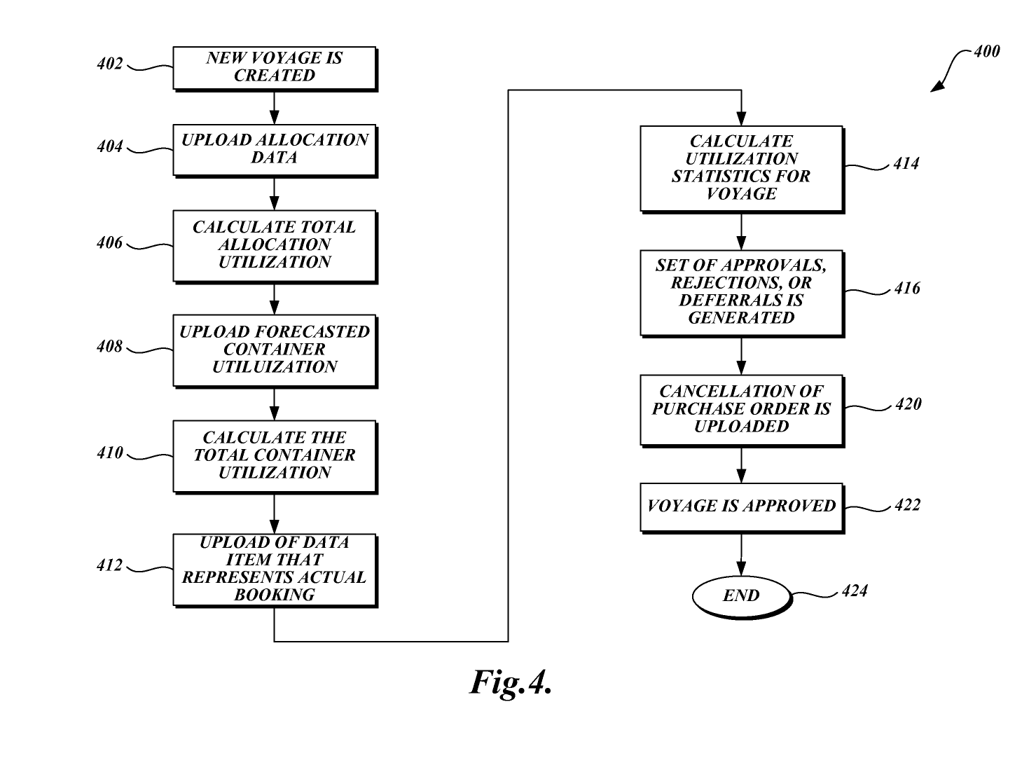

Now with reference to FIG. 4, a method 400 in which a new voyage is created and ultimately approved will be described. As illustrated in FIG. 4, the method 400 begins at block 402 where a new voyage is created. In one embodiment, a user may create a new voyage, at block 402, by activating the add voyage button 308 described above with reference to FIG. 3. In this instance, the user may be directed to a Web page that obtains input that describes the voyage being created. However, set times may be established so that only particular users have sufficient access rights to create a new voyage. For example, only those users associated with a particular entity or other subset of users have sufficient access rights to create a new voyage. In this regard, the present invention compares the users credentials obtained at login against the access rights required to perform a particular action. In instances when sufficient authority to perform the requested action does not exist, the present invention may inform the user that the requested action could not be completed.

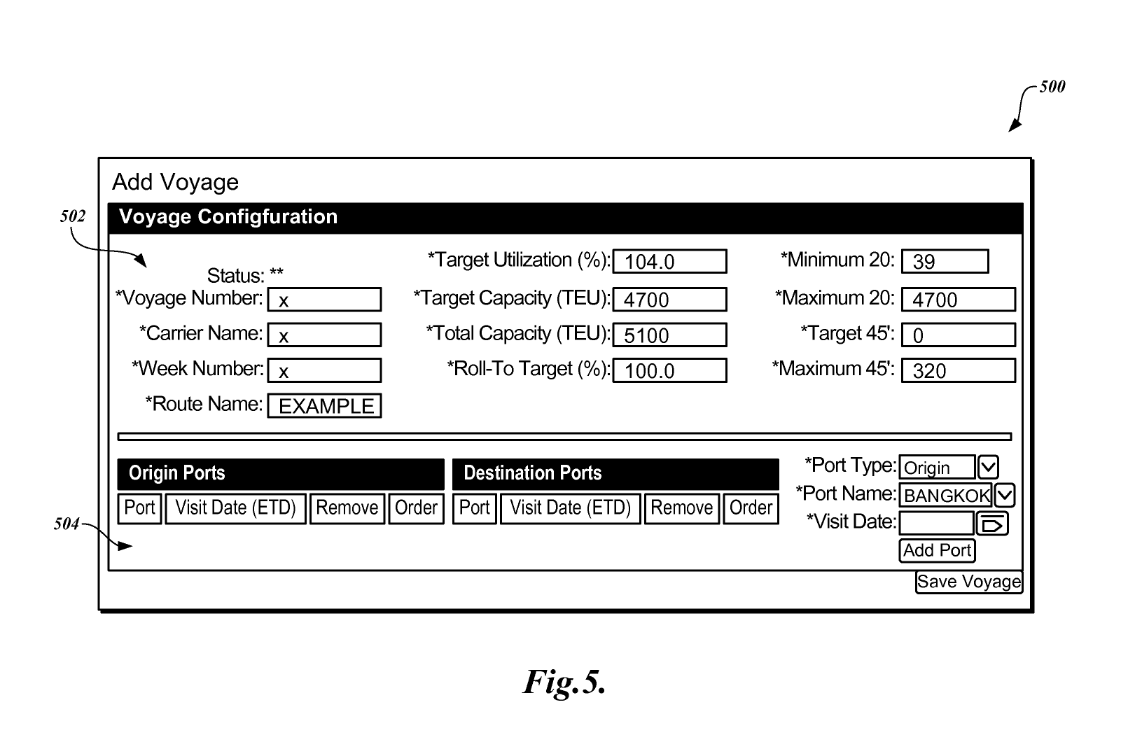

Now with reference to FIG. 5, an exemplary Web page 500 with controls that may be used to obtain data when a voyage is being created will be described. For illustrative purposes, the Web page 500 comprises a first input area 502 and a second input area 504. The first input area 502 includes text boxes that allow a user to enter a voyage number, carrier name, week number, etc. The data presented in the additional text boxes in the first input area 502 will typically be set by default but may be modified, if necessary. By interacting with controls available from the second input area 504, a user may input origin and destination ports, port type and name, and scheduled dates for each port. In this regard, the data input into the Web page 500 may be saved in the voyage database 210 and recalled on demand.

Again with reference to FIG. 4, once a new voyage is created, entities may upload various data items that are related to the voyage. In the example depicted in FIG. 4, allocation data for a voyage is uploaded using the Web interface 200, at block 404. Generally described, allocation data for a voyage identifies the cargo space that is being allocated between a particular origin/destination port combination. The allocation data may be uploaded, at block 404, as a comma separated file (“CSV”), with each row of the file identifying the cargo space being allocated to each origin/destination port combination. For example, a first row to the CSV file may identify an origin port (“Shanghai”), a destination port (“Los Angeles”), and the number of forty-foot equivalent units (“FEUs”) that are being allocated to this origin/destination port combination. Other rows identify the number of FEUs being allocated to other origin and destination port combinations (e.g., “Shanghai” and “Oakland”). While specific files and data types have been described above, those skilled in the art and others will recognize that these examples should be construed as exemplary and not limiting. For example, aspects of the present invention may utilize a different file type other than a CSV file when obtaining data.

In an actual embodiment, aspects of the present invention coordinate the movement of cargo using particular types of carriers. Accordingly, the examples provided herein are described with reference to units of cargo (e.g., FEUs and TEUs) that are conventionally used by these carriers. However, those skilled in the art and others will recognize that the invention may be implemented in other contexts without departing from the scope of the claimed subject matter. As such, the illustrative examples and descriptions provided herein with regard to particular types of carriers and cargo units are not intended to be exhaustive or to limit the invention to the precise forms disclosed.

At block 406, the method 400 calculates a total allocation utilization percentage for the voyage that accounts for the allocation data uploaded at block 404. The allocation of capacity by a carrier may be quantified in twenty-foot equivalent units (“TEUs”). As described above, data may be uploaded in different units such as FEUs. Thus, calculating a total allocation percentage for the voyage may include summing the FEUs that are allocated to the different origin/destination combinations. Then, the total FEUs for all the origin/destination ports may be converted to a total TEU value. This total TEU value may then be divided by the available capacity represented in TEUs to identify a utilization percentage. The utilization data that is calculated, at block 404, may be readily accessed by a user from the Web interface 200.

As further illustrated in FIG. 4, forecasted container utilization data for origin/destination port combinations is uploaded, at block 408. Similar to the description provided above, the forecasted container utilization data may be represented in a CSV file. Those skilled in the art will recognize that many different types of containers may be used in transporting cargo. Common container types used by some carriers include standard 20′, 40′, 45′, 53′ containers, as well as 40′ High Cubed (“40HC”) and 40′ High Cubed Refrigerated (“40HR”) containers. In one embodiment, each row of the CSV file uploaded at block 408 includes estimates for each container type. Accordingly, each row to a CSV file may identify an origin/destination port combination and the number of each 20′, 40′, 45′, 53′, 40HC, and 40HR containers allocated to the associated port combination. The forecasted container utilization data is stored in the voyage database 210 and may be accessed from the Web interface 200, as described in further detail below.

At block 410, the method 400 calculates the total container utilization of the voyage that accounts for previously uploaded data. Calculating the container utilization value may include summing the total numbers of each container type (e.g., 20′, 40′, 45′, 53′, 40HC, and 40HR) that are scheduled to be shipped. Then, the total capacity of each container type is converted into an equivalent total TEU capacity based on the conversion equivalents represented in Table 1.

TABLE 1

| Container | TEU |
|---|---|
| 20′ Container = | 1 |
| 40′ Container = | 2 |
| 40HC Container = | 2.3 |
| 53′ Container | 2.65 |
| 40HR Container = | 2 |
| 45′ Container = | 2.6 |

The total capacity for each container type converted into TEUs is summed and divided by the available capacity represented in TEUs to identify a total container utilization value. Similar to the descriptions provided above, the utilization value that is calculated at block 410 may be accessed from the Web interface 200.

As further illustrated in FIG. 4, at block 412, a data item is uploaded that represents a booking of actual cargo and/or equipment that is being scheduled for shipment on the voyage. Those skilled in the art and others will recognize that planning a voyage may take weeks or months to perform. Initially, cargo space is allocated based on available carrier capacity for the voyage. Then, the actual cargo and equipment that are scheduled to be shipped is identified. In the exemplary embodiment depicted in FIG. 4, a user uploads a set of data, at block 412, to book cargo and/or equipment for shipment. The data item uploaded may be in the form of a purchase order, container list, etc. Similar to the description provided above, this data may be represented in a CSV file and uploaded using graphical elements (i.e., buttons, icons, menus, etc.) available from the Web interface 200. In this regard, the Web interface 200 is an event-driven system that allows remotely located users to upload files to a centralized network location. For example, a user associated with an exporter may allocate cargo space available from a carrier based on a projected need for cargo at various locations. Then, other users/entities involved in the shipment may book or otherwise identify the actual cargo and/or equipment that will be included in the current voyage. Accordingly, data is collected and disseminated in a way that enables real-time collaboration between different entities involved in a shipment.

By way of example, a user may upload a purchase order that represents a contract between a buyer and seller at block 412. In one embodiment, purchase orders uploaded to the Web interface 200 include a standardized set of data that includes, but is not limited to, purchase order type, description of goods, buyer and seller names, etc. As described in further detail below, each uploaded purchase order may be subject to “approval” by an authorized user. In this regard, data may be included with a purchase order to differentiate between cargo that should be shipped on this voyage with cargo that may be “rolled” to a different voyage. In addition or separate from a purchase order, a user may upload a container list, at block 412, that identifies the containers that are scheduled to be used transporting cargo on the current voyage. In this regard, an uploaded container list may also contain a standardized set of data that includes a list of container identifiers, associated purchase orders, container type (e.g., 20′, 40′, 45′, 53′, 40HC, and 40HR), status, and the like.

At block 414, the method 400 calculates utilization statistics for the actual cargo and/or equipment currently scheduled to be included in the current voyage. As described above, various forecasted utilization statistics are calculated when cargo space is initially allocated. Similarly, utilization statistics that are based on the actual cargo and/or equipment scheduled to be shipped are calculated based on actual bookings. Accordingly, a purchase order bookings utilization may be calculated that accounts for a previously uploaded purchase order. Moreover, an actual container utilization value may be calculated that accounts for the containers currently allocated to transport cargo represented in these booked purchase orders. In this regard, calculating the actual container utilization value may include summing the total capacity of the different container types (e.g., 20′, 40′, 45′, 53′, 40HC, and 40HR) being used to satisfy the booked purchase orders. Then the total capacity for each container type is converted into TEUs according to the conversion formula in Table 1 above. The converted TEU capacity for the different container types is summed and divided by the total TEU capacity to identify the booked container utilization value. In this regard, a difference in the purchase order booking and container utilization values may exist in instances when the containers are not fully utilized.

In one embodiment, each booked purchase order is allocated a status designation (referred to herein as Status A, Status B, and Status C) that relates to the delivery status of the purchase order. By way of example, when a purchase order is designated as having a Status C, the cargo represented in the purchase order will not arrive for transport on the current voyage on schedule. In one embodiment, an authorized user must issue an “approval” to allow the cargo represented in a Status C purchase order to be delayed. In the method 400 depicted in FIG. 4, a user generates a set of approvals, rejections, or deferrals, at block 416, for a set of purchase orders that maintain a Status C designation. In this regard, an “approval” indicates that cargo represented in the purchase order may be shipped on a different voyage. In contrast, if a purchase order is “rejected” this provides an indicator that the cargo may not be delayed. When a purchase order is “deferred” by the current user, another user is assigned the task of determining whether to approve or reject the purchase order.

As further illustrated in FIG. 4, at block 420, a cancellation of a purchase order is uploaded to the Web interface 200 provided by the present invention. An authorized user may cancel one or more purchase orders by uploading a CSV file that contains a set of cancellation data that may include one or more purchase order numbers and the reason for cancellation. In this regard, canceled purchase orders may be re-assigned for delivery on a different voyage. The status designation and cancellation of purchase orders illustrates another way in which aspects of the present invention allow different entities to collaborate. By way of example, a carrier may assign a purchase order a Status C designation to indicate that a delay has occurred in delivering the cargo for shipment on the current voyage. An exporter may access the Web interface 200 and issue an “approval,” thereby providing the necessary authority to allow this cargo to be shipped on a different voyage. In instances when a cancellation occurs, the system assigns a “canceled” status to the appropriate purchase order. Then, the utilization statistics for the voyage are recalculated to reflect the cancellation. In this regard, users may access the Web interface 200 provided by the present invention and perform a search for purchase orders that have a “canceled” status. Moreover, reports may be generated using the present invention to identify the cancellation history for particular carriers, voyages, and the like.

In the exemplary embodiment depicted in FIG. 4, the current voyage is approved for shipment at block 422. As described above, aspects of the present invention provide a centralized location for managing the collection and dissemination of data related to a shipment. Before approval of a voyage by an authorized user, purchase orders that identify cargo scheduled to be shipped are received. However, cargo scheduled to be shipped may be modified before the voyage is approved. For example, the delivery of cargo for shipment on the current voyage may be delayed. In this instance, a purchase order may be “canceled” and one or more containers associated with the canceled purchase order may be “rolled” to a different voyage. When this type of modification occurs, utilization statistics are recalculated. The dynamic updating of utilization statistics performed by aspects of the present invention is beneficial in determining whether to approve a voyage. For example, a user may access “up-to-date” booked purchase order utilization data from the Web interface 200 to determine whether the capacity available from the carrier is sufficiently utilized. Moreover, mechanisms may be implemented so that a voyage cannot be approved unless certain requirements are satisfied. In any event, an authorized user may approve the current voyage, at block 422, by activating the appropriate controls available from the Web interface 200. Then, once the voyage is approved, the method 400 proceeds to block 424, where it terminates.

As noted above, an event-driven interface provided by the present invention allows remotely located users to upload data related to a shipment. In this regard, the method 400 depicted in FIG. 4 is used to provide an exemplary description of one way in which a voyage may be created and approved to enable collaboration between different users. However, since an event-driven interface is provided, the description provided with reference to FIG. 4 is merely exemplary. For example, the present invention is configured to collect data with regard to actual bookings of cargo and/or equipment from multiple entities. Accordingly, certain steps described with reference to FIG. 4 will typically be performed in an iterative manner. Moreover, certain steps depicted in FIG. 4 may be performed in a different order than described or omitted altogether. Accordingly, implementations of the present invention are not limited to the method 400 described with reference to FIG. 4.

As mentioned above, one aspect of the present invention is a Web interface 200 that leverages the network connectivity of the Internet to manage voyage logistics. At login, a user may initially access a “home” page (e.g., Web page 300) that presents an overview of the currently scheduled voyages. In this example, the various controls available from the Web page 300 allow authorized users to access all of the information related to one or more voyages.

In one aspect, a user may search and access information about a plurality of voyages. In this regard, the Web page 300 (FIG. 3) includes a the sidebar region 302 with a “PO BOOKINGS” control 310, “CONTAINERS” control 312, “CANCELLATIONS” control 314, and “UPLOADS” control 316. When one of the these controls is activated, the user is directed to a location where detailed information about the selected data item may be accessed. For example, the “PO BOOKINGS” control 310 allows users to access a purchase order search page. From the purchase order search page, a user may input one or more criteria and ultimately access purchase orders that satisfy the criteria. In this regard, the criteria input by the user to identify relevant purchase orders may include voyage number, status designation (e.g., Status A, Status B, and Status C), purchase order identifier, discharge/destination ports, and the like. In a similar fashion, a user may search and access information with regard to containers, cancellations, and upload sessions.

In another aspect, the Web interface 200 allows users to “drill down” and access particular data sets associated with a selected voyage. A user may select a voyage by, for example, activating a control available from the description regions 304-306 (FIG. 3). Alternatively, a user may select the “VOYAGES” control 318 from the sidebar region 302 to access a voyage search page.

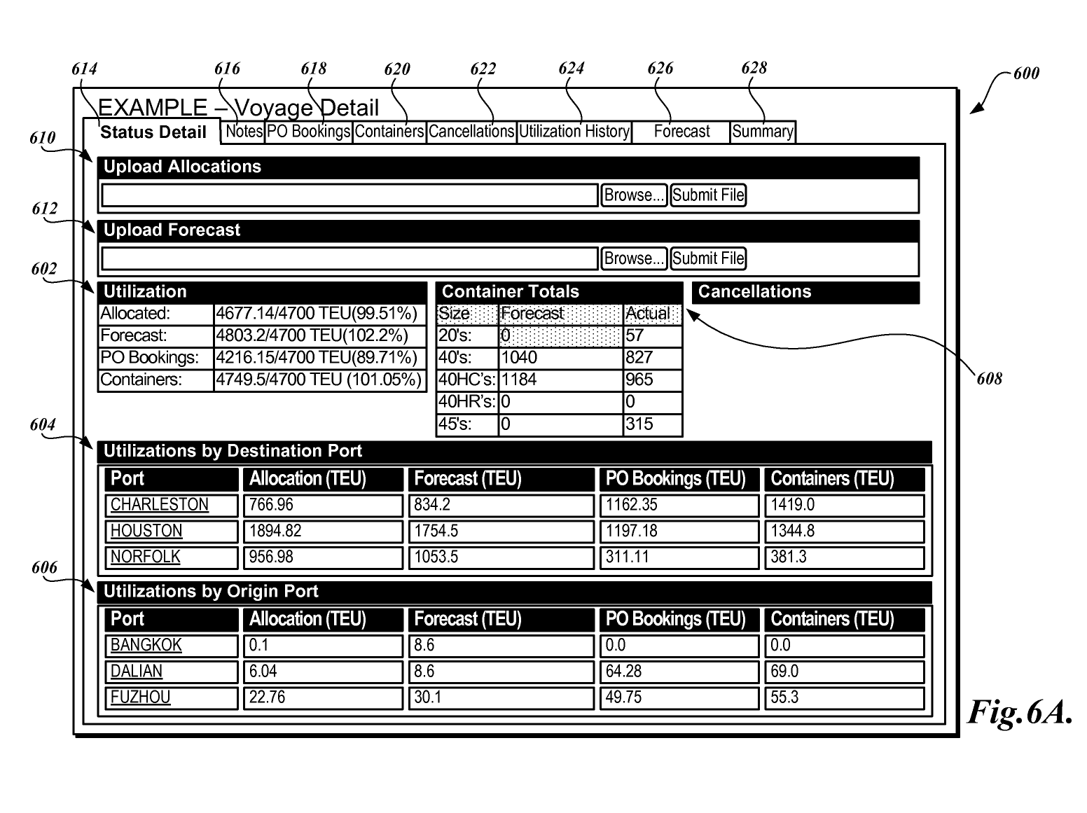

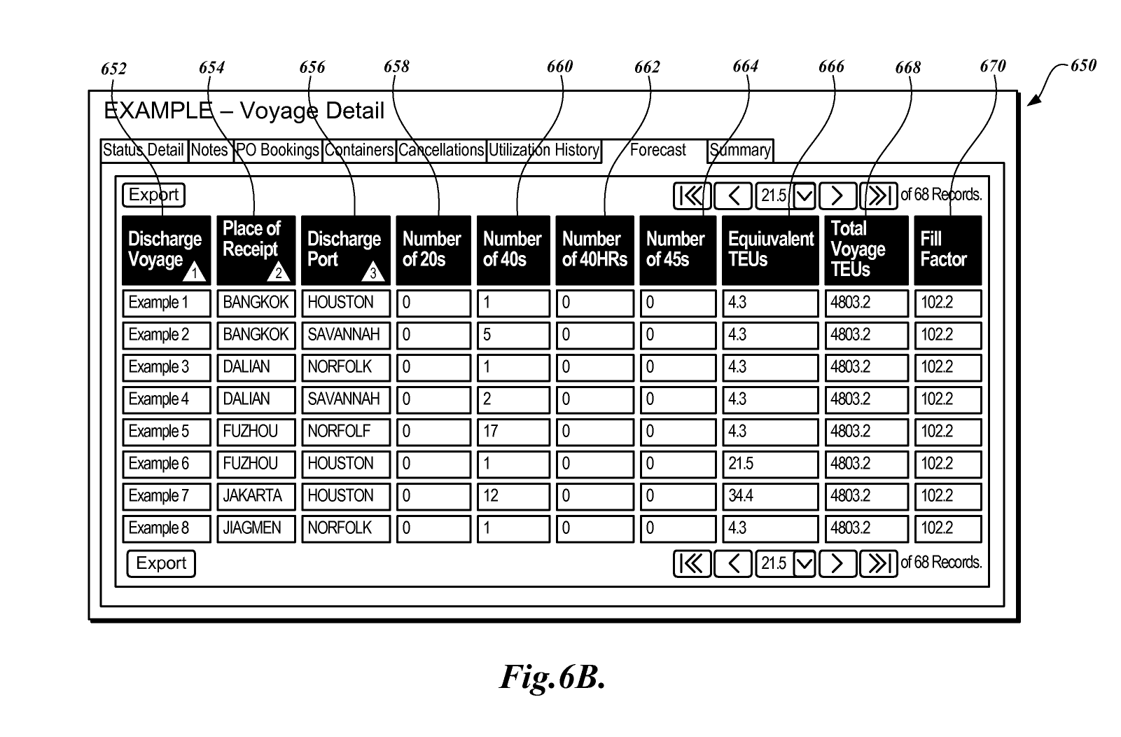

Now with reference to FIGS. 6A-B, additional aspects of the Web interface 200 that may be used to illustrate aspects of the invention will be described. The Web page 600 depicted in FIG. 6A may be presented by default when a user selects a specific voyage. In this example, the Web page 600 includes a utilization summary region 602 that presents utilization statistics associated with the voyage. Utilization statistics associated with the voyage are further parsed and displayed relative to the voyage's ports in the destination and origin port regions 604-606, respectively. Moreover, the Web page 600 also includes a container region 608 that presents the forecasted and the current number of each container type (e.g., 20′, 40′, 45′, 53′, 40HC, and 40HR) associated with the voyage.

The controls available from the Web page 600 allow users to upload allocated and forecasted utilization data for the selected voyage. In this regard, a user may generate input using controls available from the allocation region 610 to identify and upload a file that contains allocation data. For example, the method 400 described above with reference to FIG. 4 may obtain a CSV file that contains allocation data in this way (at block 404). Similarly, a user may interact with controls available from the OCM forecast region 612 to identify and upload forecasted utilization data. As described above, when data is input into the Web interface 200, calculations that account for the received data are performed so that “up-to-date” information is available to users. As further illustrated in FIG. 6A, the Web page 600 includes the tabs 614-628 for navigating between the various pages associated with the selected voyage.

Now with reference to FIG. 6B, another exemplary Web page 650 accessible from the Web interface 200 will be described. In one embodiment, the Web page 650 may be displayed when the tab 626 (FIG. 6A) is activated. As illustrated in FIG. 6B, the Web page 650 presents the number of each container type (e.g., 20′, 40′, 45′, 53′, 40HC, and 40HR) allocated to the voyage relative a origination/destination port combinations. In this regard, the data presented on the Web page 650 is organized into the columns 652-670 that each presents a different data item. More specifically, the columns 654 and 656 collectively identify an origin/destination port combination. The container type columns 658-664 present the number of each container type scheduled to be transported between these ports. Moreover, the equivalent TEU capacity column 666 presents the total capacity for all the scheduled containers represented in TEUs.

Those skilled in the art and others will recognize that the highly granular level in which data may be accessed using the present invention alleviates numerous logistical shortcomings of existing systems. As described above with reference to FIGS. 6A-B, the present invention allows user to select and access detailed informational views about one or more voyages. However, it should be well understood that the Web pages described herein are merely exemplary of the types of features and data items that are accessible from the Web interface 200. In an actual embodiment, a user may access additional types of data and features about a selected voyage. By way of example only, a user may activate the tab 618 (FIGS. 6A-6B) to access a purchase order bookings page. Among other things, the purchase order bookings page allows a user to perform uploads, search and view purchase orders that satisfy a criteria, and approve/reject purchase orders. Similarly, the tab 620 may be activated to access a containers page that allows a user to perform uploads of container data, access container roll statistics, search container data, and the like. Moreover, the tab 622, may be activated to access a cancellations page that allows a user to upload a cancellation, search for cancellations that satisfy a criteria, and view a cancellation history.

While illustrative embodiments have been illustrated and described, it will be appreciated that various changes can be made therein without departing from the spirit and scope of the invention.

The embodiments of the invention in which an exclusive property or privilege is claimed are defined as follows:

1. In a computer networking environment that includes a plurality of remotely connected computing devices, a method of managing the logistics of a voyage, the method comprising:
providing a user interface that is accessible in the computer networking environment configured with controls for accepting input from one or more users;
collecting a set of voyage data from the user interface that describes the attributes of the cargo scheduled to be shipped on the voyage;
calculating a set of utilization statistics based on the collected voyage data that describes the extent that the available capacity will be utilized; and
making the collected voyage data and utilization statistics accessible from the user interface.

2. The method as recited in claim 1, wherein the controls accessible from the user interface allow users to upload at least one data item from the group consisting of a purchase order, forecasted container utilization data, and port allocation data.

3. The method as recited in claim 1, wherein collecting a set of voyage data from the user interface that describes the attributes of the cargo scheduled to be shipped includes enforcing access rights so that a subset of voyage data may only be collected from a particular entity.

4. The method as recited in claim 1, wherein collecting a set of voyage data from the user interface that describes the attributes of the cargo scheduled to be shipped on the voyage includes:
allowing a first entity allocate a status designation to a purchase order; and
allowing a second entity issue an approval that provides the sufficient level of authority to ship the cargo represented in the purchase order on a different voyage.

5. The method as recited in claim 1, wherein collecting a set of voyage data from the user interface that describes the attributes of the cargo scheduled to be shipped includes allocating each uploaded purchase order at least one rule designation from the group consisting of gold, platinum, and non-platinum.

6. The method as recited in claim 1, wherein calculating a set of utilization statistics includes converting the cargo capacity of a plurality of container types into twenty-foot equivalent units.

7. The method as recited in claim 1, wherein calculating a set of utilization statistics includes calculating at least one utilization statistic from the group consisting of a total allocation utilization, total purchase order bookings, and total forecasted container utilization.

8. The method as recited in claim 1, wherein making the collected voyage data and utilization statistics accessible from the user interface includes determining whether a particular user has sufficient access rights to access the voyage data.

9. The method as recited in claim 1, wherein making the collected voyage data and utilization statistics accessible from the user interface includes allocating authority to access functionalities from the user interface based on the role of an entity in completing a shipment.

10. A computer-readable medium having computer executable components for managing the collection and dissemination of voyage data, comprising:
an access rights component that manages user's right to access data and perform actions when interacting with the user interface component;
a calculation component that generates utilization statistics for a voyage data based on received input;
an user interface component operative to:
receive input to create a new voyage and collect a set of voyage data that describes the attributes of cargo scheduled to be shipped on the voyage, the voyage data including at least one data item from the group consisting of a purchase order, forecasted container utilization data, and port allocation data; and
display output that presents utilization statistics calculated by the calculation component, wherein the utilization statistics identify the extent that the capacity available from a carrier will be utilized based on voyage data received from at least two users.

11. The computer-readable medium as recited in claim 10, further comprising a shipment search engine that applies a search algorithm to identify data maintained in a database related to a keyword.

12. The computer-readable medium as recited in claim 10, wherein the shipment search engine is further configured to allow users to accept or reject an uploaded purchase order.

13. The computer-readable medium as recited in claim 10, wherein the access rights component is further configured to allocate access rights to multiple entities and wherein the access rights granted vary depending on the role of each entity.

14. The computer-readable medium as recited in claim 10, wherein the utilization statistics calculated by the calculation component includes at least one statistic from the group consisting of total allocation utilization, total purchase order bookings, and total forecasted container utilization.

15. A computer system that provides a centralized network location where voyage data may be accessed by remote computer users, comprising:
one or more client computing devices that include an application program for accessing content available from a computer networking environment;
a management server communicatively connected to the one or more client computing devices, wherein the management server executes a management application configured to:
collect a set of voyage data from users associated with the one or more client computing devices that describes the attributes of cargo scheduled to be shipped;
store and aggregate the collected voyage data;
provide an interface that accepts requests from the one or more client computing devices for specific sets of voyage data;
satisfy requests received from the one or more client computing devices; and
a voyage database operative to store voyage data obtained by the management server and satisfy queries that identify specific sets of voyage data.

16. The system as recited in claim 15, wherein the management application is further configured to allow modifications to the cargo that will be shipped before a voyage is approved.

17. The system as recited in claim 15, wherein the management application is further configured to allocate authority in collecting and satisfying requests for voyage data to multiple entities wherein a variable amount of authority is granted based on the role of an entity in completing a shipment.

18. The system as recited in claim 15, wherein to provide an interface for accepting requests from the one or more client computing devices includes implementing controls that allow users to upload at least one data item from the group consisting of a purchase order, container list, and port allocation data.

19. The system as recited in claim 15, wherein to satisfy requests received from the one or more client computing devices includes calculating utilization statistics that identify the extent that the capacity available from a carrier will be utilized.

20. The system as recited in claim 19, wherein the utilization statistics that are calculated include at least one statistic from the group consisting of total allocation utilization, total purchase order bookings, and total forecasted container utilization.
